(19) United States
(12) Patent Application Publication
(10) Pub. No.: US 2008/0023379 A1
(43) Pub. Date: Jan. 31, 2008

(54) MEDIA SEPARATION SYSTEMS AND METHODS

(75) Inventors: Russell A. Potterfield, Columbia, MO (US); Tim Morrow, Jefferson City, MO (US); Jacob Dale, Moberly, MO (US)

Correspondence Address: PERKINS COIE LLP;PATENT-SEA, P.O. BOX 1247, SEATTLE, WA, 98111-1247, US

(73) Assignee: Battenfeld Technologies, Inc., Columbia, MO (US)

(21) Appl. No.: 11/740,908

(22) Filed: Apr. 26, 2007

Related U.S. Application Data
(60) Provisional application No. 60/795,624, filed on Apr. 26, 2006.

(51) Int. Cl. B07C 9/00

(52) U.S. Cl. 209/689

(57) ABSTRACT

A media separator system includes a first and a second portion of a media separator device, a projection, a handle, at least one of a retention device, and a storage container, wherein the first and second portion of the media separator device, the handle and the at least one of a retention device is sized to be received at least partially in the storage container.

### CROSS-REFERENCE TO RELATED APPLICATION

This application claims the benefit of U.S. Provisional Patent Application No. 60/795,624, filed Apr. 26, 2006, which is incorporated by reference herein.

### TECHNICAL FIELD

The present disclosure is directed to media separation systems and methods, such as rotary media separation devices for use with firearm casings.

### BACKGROUND

Many shooters choose to clean and reload brass cartridges or casings after use as a hobby. Vibratory tumblers are often used to clean and polish the firearm casings for reloading. Typically, a batch of casings is placed in a vibratory tumbler with an abrasive or polishing media. The tumbler vibrates the casings so that the casings rub against each other and the abrasive or polishing media. The contact between different casings and between the casings and the media removes dirt, grease, lubricants, powder stains, and/or tarnish from the casings. After the casings are cleaned, the media must be separated from the casings. In most cases, the media material is ground corn cob. The media matter is smaller than the opening at the front of the brass cartridge case, and thus the cases fill with particles during the tumbling process. At the end of the tumbling process, the user must separate the media from the brass cartridge cases. This can be done by hand, with a sieve, or with an alternative media separator device.

Various media separator devices have been used in the past, but there remains a need for a cost efficient, versatile media separator device that can be easily shipped, stored and/or assembled. Accordingly, there exists a need to improve existing media separator devices.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1A is a schematic isometric view of a media separator system for separating media from firearm casings in accordance with one embodiment of the invention. FIG. 1B is a schematic isometric view of the media separator system of FIG. 1A shown in an open position.

FIG. 2 is a schematic top view of the media separator system illustrated in FIG. 1A.

FIG. 3 is a schematic side view of the media separator system illustrated in FIG. 1A.

FIG. 4 is a schematic rear view of the media separator system illustrated in FIG. 1A.

FIG. 5 is a schematic isometric view of a media separator system in accordance with another embodiment of the invention.

FIG. 6 is a schematic top view of the media separator system illustrated in FIG. 5.

FIG. 7 is a schematic left side view of the media separator system illustrated in FIG. 5.

FIG. 8 is a schematic isometric view of a media separator device in accordance with another embodiment of the invention.

FIG. 9 is a schematic top view of the media separator system illustrated in FIG. 8.

FIG. 10 is a schematic isometric view of the media separator system in accordance with another embodiment of the invention.

FIG. 11 is a retention device for use with the media separator system in accordance with another embodiment of the invention.

### DETAILED DESCRIPTION

A. Overview

The following disclosure describes several embodiments of media separator devices (e.g., rotary media separator devices) and media separator systems. One aspect of the invention is directed to a rotary media separator for separating media from a firearm workpiece, such as a casing. In one embodiment, a media separator system includes a separator body having apertures configured to release the media and retain a workpiece or casing, a support frame and retention devices releasably retaining the separator body to the support frame. The support frame may include a bucket, a tray, a container, a hopper, a tumbler enclosure or other external support surface.

In another embodiment, a media separator system includes a multi-piece substantially hollow separator body, a support container and retention devices releasably retaining the separator body to the support container. The separator body is constructed from multiple interlocking pieces and may be dismantled when not in use for ease in shipping and storing. According to other embodiments, the support container is sized to allow the dismantled separator body and retention devices to be received at least partially in the support container.

In another embodiment, a media separator system includes a rotary media separator body, a support frame and a connection device for releasably coupling the separator body to the frame. The connection device further includes a receiving member for receiving a rotational element of the media separator body. According to one embodiment, the connection device is a collar at least partially encircling a rim of a bucket. According to another embodiment, the connection device is at least one of a bracket or clip.

In another embodiment, a media separator system includes a rotary media separator body, a support frame and a retention device for releasably coupling the separator body to the frame. The inside of the separator body may be substantially hollow. The inside of the body may be divided into one or a plurality of cavities and further includes at least one of an access port configured to allow media and workpieces to be added into or removed from at least one of the cavities. The generally rigid body can be formed of a plastic, polymer, and/or rubber. The separator body, support frame, retention devices and/or other components of the system may be molded or cast. According to one embodiment, one or more regions of the separator body includes apertures sized to allow media material to pass therethrough and further sized to retain workpieces.

In another embodiment, a media separator device comprising a series of adjoining surfaces defined in three dimensions to releasably interconnect to form a simple or complex body shape. The inside of the defined shape may be substantially hollow and configured to receive media and workpieces such as firearm casings. The inside of the body may be divided into one or more cavities. At least one of an access port in the perimeter of the body to permit the introduction and/or removal of the media and workpieces. The media separator device further includes retention devices for releasable retaining the device to a supporting substructure. According to other embodiments, the media separator device further includes apertures in the perimeter of the body sized to allow the media material to pass through and retain the workpieces.

In another embodiment, a media separator system includes a first and a second portion of a media separator device, a projection, a handle, at least one of a retention device, and a storage container, wherein the first and second portion of the media separator device, the handle and the at least one of a retention device is sized to be received at least partially in the storage container.

In another embodiment, a media separator device comprising a plurality of support clamps that are designed to support the separator body, wherein the support clamps do not fully encircle the top of the bucket being used to collect media after use. The support clamps can removeably engage (e.g., snap on) the top lip of a bucket. The support clamps may engage, carry or support a handle and a projection without contacting the two-piece separation device. According to other embodiments, a two-part separator body further includes slots sized to allow for media drainage upon rotation but yet retain the workpieces within the body. The two portions of the separator body can be pivotally connected on one side with a hinge such that the two portions can be pivoted open to load workpieces and media into the body and then pivoted closed for rotating the separator body to separate the workpieces and the media. The two portions of the separator body may further include a securing mechanism such as a clip, clasp, lock or detent to keep the two portions of the body from opening during operation. The two portions of the separator body are configured so that at least one can partially nest or be received within the other when not in use, such as during transit or in storage. The two portions of the separator body are also sized to be received at least partially in the bucket. The support clamps, handle, and projection may also fit within the bucket with the separator body. This reduces the size of the device for shipping. A handle may further be contained on a first projection. A first and a second projection are sized to removeably engage at least one of the two portions of the body. The handle, and the first and the second projection are supported by the support clamps, and the handle enables a user to easily turn the media separation device.

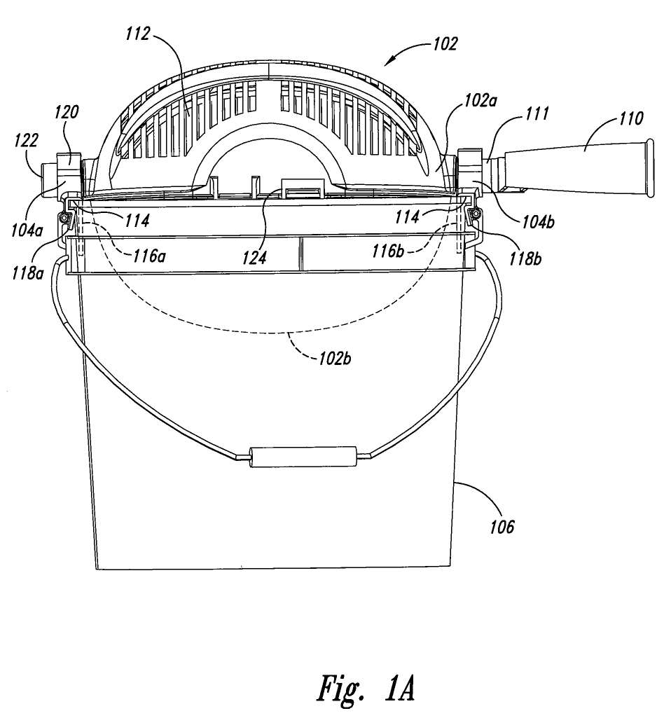

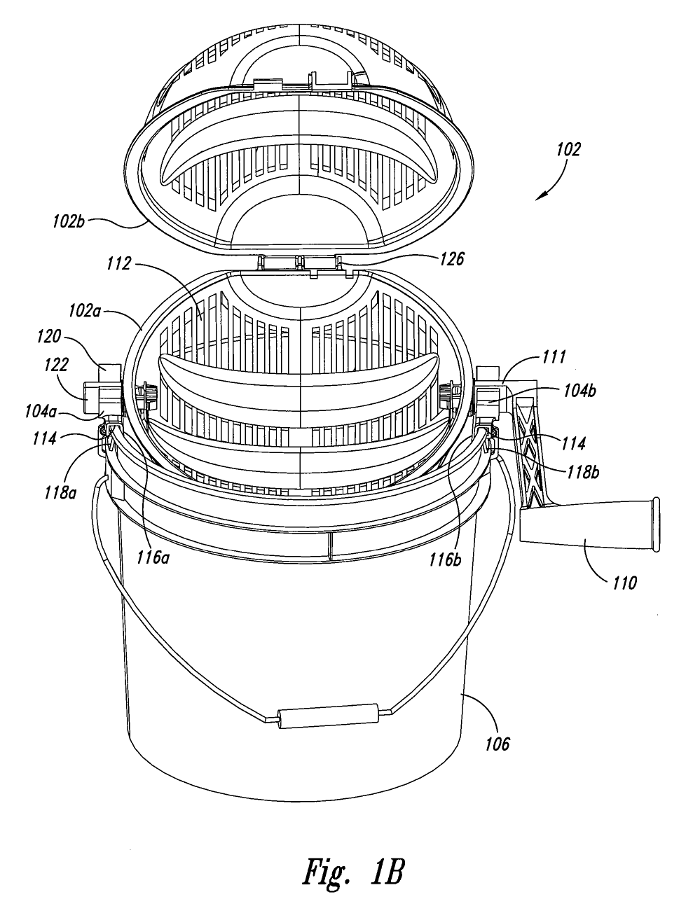

Specific details of several embodiments of the invention are described below with reference to media separator systems, media separator devices and media separator assemblies. Several details describing well-known structures or processes often associated with media separator devices are not set forth in the following description for purposes of brevity and clarity. Also, several other embodiments of the invention can have different configurations, components, or procedures than those described in this section. A person of ordinary skill in the art, therefore, will accordingly understand that the invention may have other embodiments with additional elements, or the invention may have other embodiments without several of the elements shown and described below with reference to FIGS. 1-11.

Where the context permits, singular or plural terms may also include the plural or singular term, respectively. Moreover, unless the word “or” is expressly limited to mean only a single item exclusive from other items in reference to a list of at least two items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same features and/or other types of features and components are not precluded.

B. Embodiments of Media Separator System

FIG. 1A is a schematic isometric view of a media separator system 100 for separating media from firearm casings (not shown for purposes of clarity) in accordance with one embodiment of the invention. The media separator system 100 includes a media separator body 102 and a support frame or structure 106. The media separator body 102 is releasably coupled to an upper support edge 114 of the support structure 106 by retention devices 104a, 104b. The retention devices 104a, 104b removeably engage the upper support edge 114 of the support structure 106 and further removeably engage a first and a second projection 111, 122. FIG. 1B is a schematic isometric view of the media separator system of FIG. 1A wherein the media separator body 102 is shown in an open position to allow loading of the media material/workpiece mixture, or to allow removal of the workpieces once the media material and workpieces have been separated.

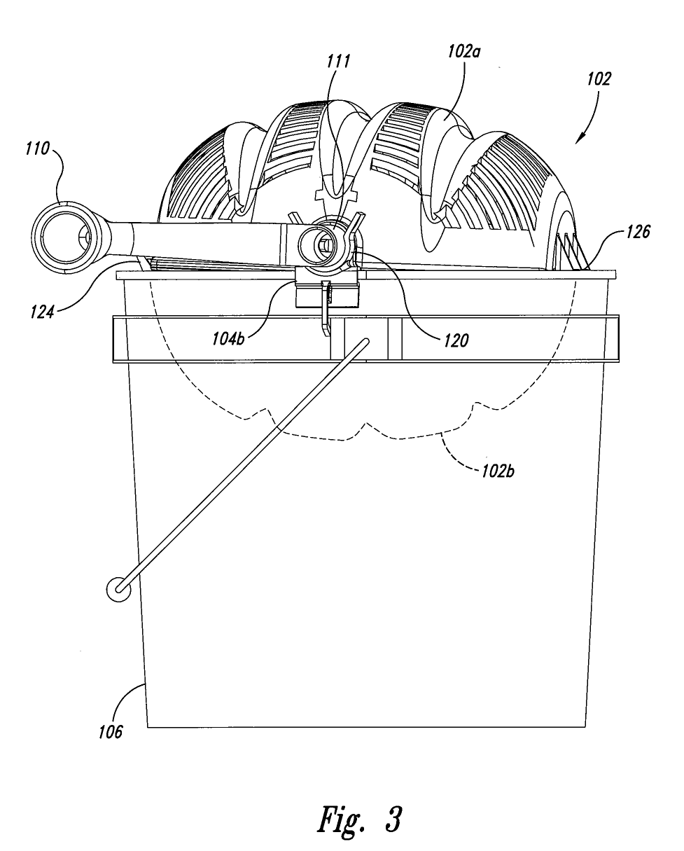

As further shown with respect to FIG. 3, the media separator device 102 includes a plurality of retention devices 104a, 104b, for example, support clamps or brackets, or other mechanical fastening devices as are known in the art, that are designed to support the separator body 102 on the support structure 106. As shown in FIG. 3, the retention devices 104a, 104b do not fully encircle the top of the support structure 106 being used to collect media after use. The retention devices 104a, 104b can removeably engage (e.g., snap on) upper support edge 114 of the support structure 106 and further removeably engages the first and second projection 111, 112. Thus, retention devices 104a, 104b may engage, carry or support the first and the second projection 111, 122 without contacting the two-piece separation device 102a, 102b.

According to the illustrated embodiments shown in FIGS. 1A, 1B, 2, 3, and 4, the retention devices 104a, 104b can include a u-shaped portion 120 for receiving either a first or a second projection 122, 111. As shown best in FIG. 1A, the first and the second projection 122, 111 extend through a sidewall of the second portion 102b of the media separation body 102 and support the media separation body 102 above the support structure 106 during operation. The u-shaped portion 120 allows the projection 122, 111 to rotate freely therein. As shown in the Figures, the second projection 111 further includes a handle 110 for rotating the media separator body 102 in operation. According to alternative embodiments, the first projection 122 may include a handle (not shown); alternatively, both the first and the second projection 111, 122 may include a handle. In operation, the handle 110 enables a user to easily turn the media separation body 102. According to yet another embodiment, no handle is provided and the media separator body 102 is rotated by rotating the projection 122 or 111.

A handle 110 may further be integral with first projection 111. A first and a second projection 122, 111 are sized to removeably engage at least one of the two portions 102a, 102b of the media separator body 102. The handle 110, and the first and the second projection 122, 111 are supported by the retention devices 104.

According to the illustrated embodiment in FIG. 1A, the retention devices 104a, 104b further include a clip having a first leg 116a, 116b and a second leg 118a, 118b wherein the first leg 116a, 116b is position on an interior of the support structure 106 and the second leg 118a, 118b is positioned on an exterior of the support structure 106. The first and second legs (116a and 118a), (116b and 118b) combine to clip the top 114 of the support structure 106 and retain the media separation device 102 thereon.

According to other embodiments, a two-part separator body 102a, 102b further includes a plurality of apertures 112 sized to allow for media (not shown) drainage upon rotation and are further sized to allow the workpieces (not shown) to remain captured within the separator body 102. As can be appreciated, the apertures 112 can take any shape including holes, slots, angular shapes, and can further include a random pattern or can include a repeating pattern or design.

According to further embodiments, the apertures may be contained on only an upper 102a or a lower 102b portion of the separator body 102 such that, for example, when the media and workpiece mixture is loaded into the media separator body 102, the mixture is placed on a solid surface such that no media is separated until the media separator body 102 is rotated. According to aspects of this embodiment, upon completion of the cleaning process in the tumbler, the media and workpiece mixture can be placed in the media separator body 102 and the media separator body 102 can be placed over the tumbler such that the tumbler serves as the support structure 106 for the media separator body 102. According to this embodiment, a support structure 106 separate from the tumbler is not required. Further, the media material flows back into the tumbler container where it can be reused to clean another batch of workpieces, thus eliminating the step of transferring the media material from a separate support structure to the tumbler.

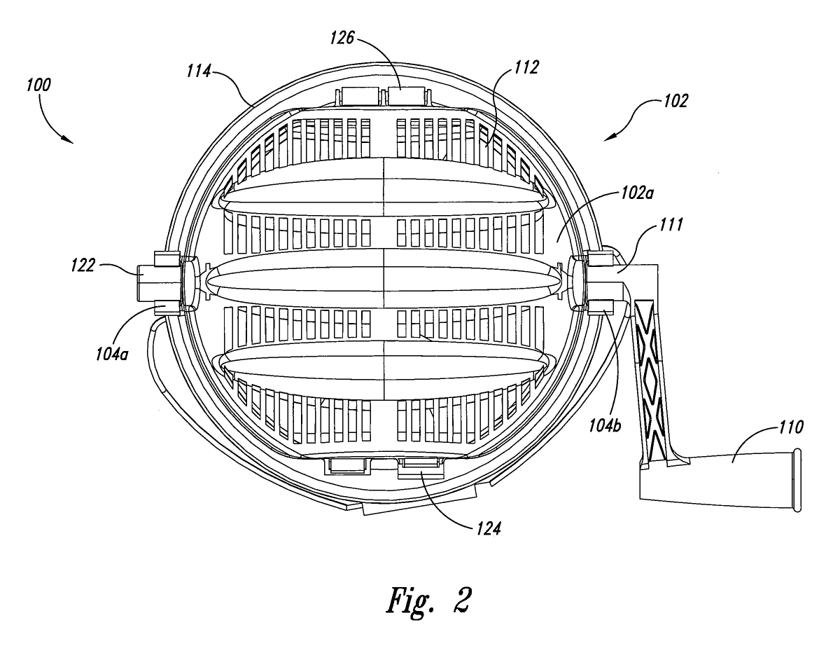

As shown with reference to FIGS. 1B and 2, the two portions 102a, 102b of the separator body 102 can be pivotally connected on one side with a hinge 126 such that the two portions 102a, 102b can be pivoted open (shown in the open configuration in FIG. 1B) to allow a media and workpiece mixture to be loaded into the body. The media separator body portions 102a, 102b are then pivoted to a closed position prior to rotation of the separator body 102.

As shown in FIGS. 1A and 2, the first and second portions 102a, 102b of the media separator body 102 may include a securing mechanism 124 such as a latch, clip, clasp, lock or detent to retain the two portions 102a, 102b of the media separator body 102 in a closed position during operation. According to alternative embodiments of the invention, the securing mechanism 124 can include a pin or keeper (not shown) to further retain the first portion and the second portion 102a, 102b in a closed position during operation.

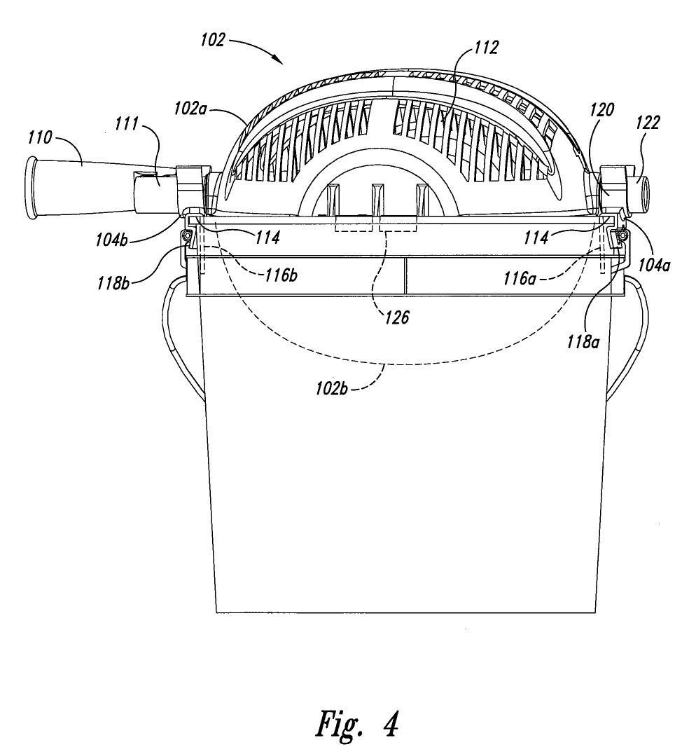

As discussed above, FIG. 2 is a schematic top view of the media separator system illustrated in FIG. 1A. FIG. 3 is a schematic side view of the media separator system illustrated in FIG. 1A. FIG. 4 is a schematic rear view of the media separator system illustrated in FIG. 1A.

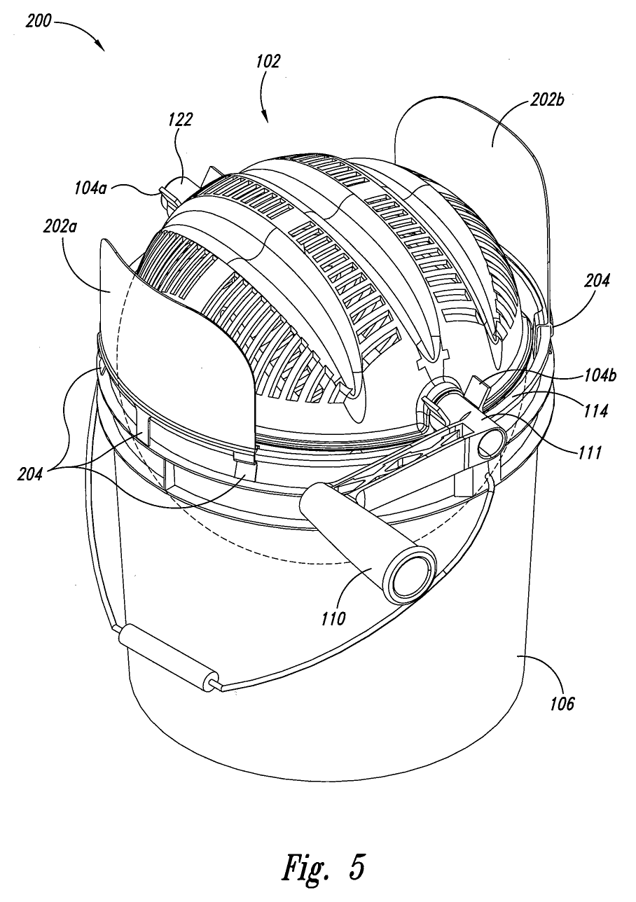

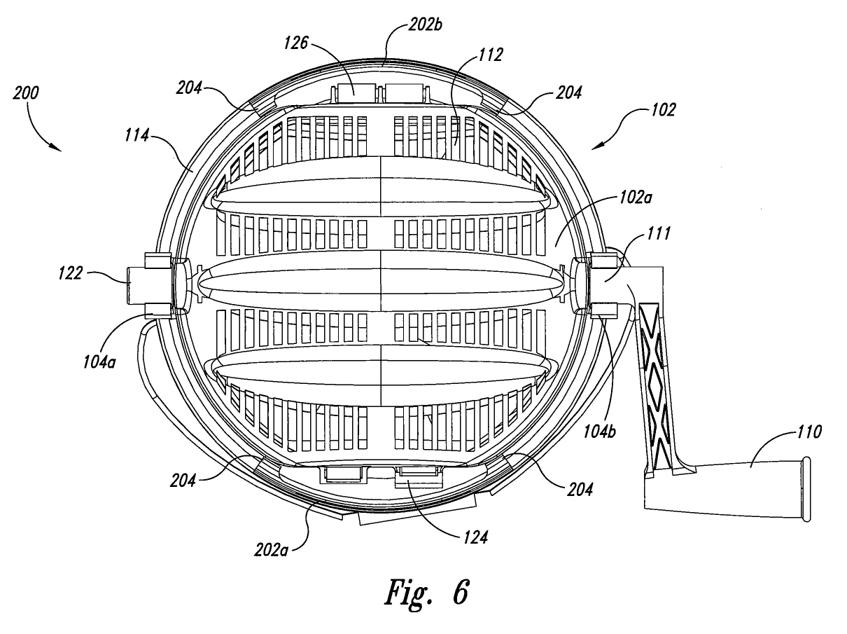

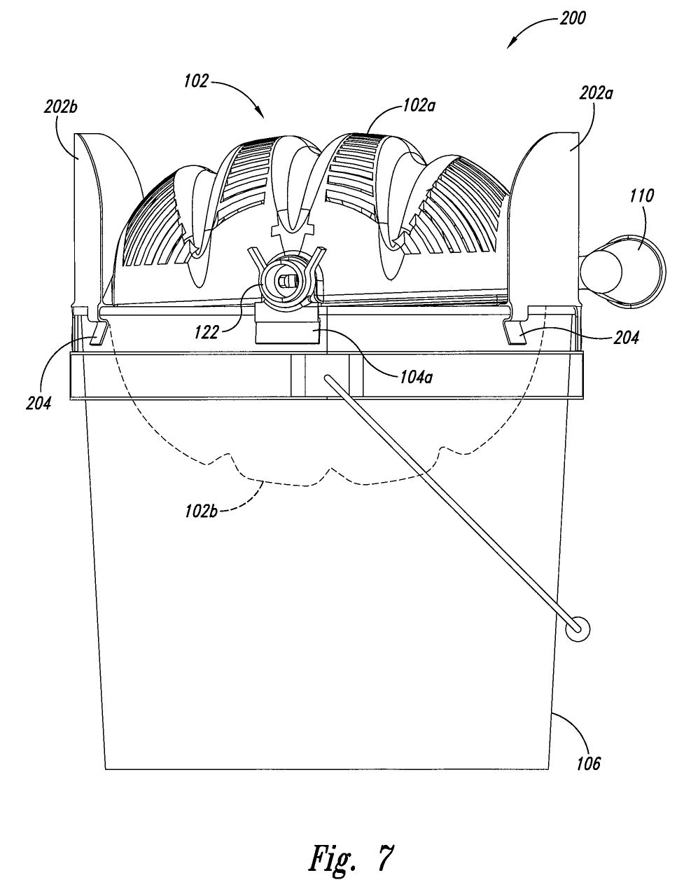

FIG. 5 is a schematic isometric view of a media separator system in accordance with another embodiment of the invention. FIG. 6 is a schematic top view of the media separator system illustrated in FIG. 5. FIG. 7 is a schematic left side view of the media separator system illustrated in FIG. 5. Like reference characters refer to like components in FIGS. 5-7 and FIGS. 1A-6, and thus the description of such components will not be repeated with reference to FIGS. 2A-C. Furthermore, FIGS. 5-7 show an alternative embodiment of the media separator system. This alternative embodiment, and those alternative embodiments and other alternatives described herein, are substantially similar to previously described embodiments, and common acts and structures are identified by the same reference numbers. Only significant differences in operation and structure are described below.

The difference between FIGS. 1A-6 and FIGS. 5-7 is that the media separation system 200 further includes a media separation device 102 having a first and a second screen or shield 202a, 202b designed to capture particulate media and direct particles into the support structure 106 rather than outside of the support structure 106. Referring now to FIGS. 5-7, the shields 202a, 202b may also removeably engage the top 214 of the support structure 106 with shield retention devices 204. The shield retention devices 204 can be integrally formed with the shield 202a, 202b. Alternatively, the shield retention devices 204 may have a first clip and a second clip wherein the first clip engages the top of the support structure 106 and the second clip engages the shield 202a, 202b. As shown in FIGS. 5-7, a first and a second shield is shown, however, as will be appreciated by those in the art, one or a plurality of shields may be included. Alternatively, as shown in FIGS. 1A-6, no shield may be included.

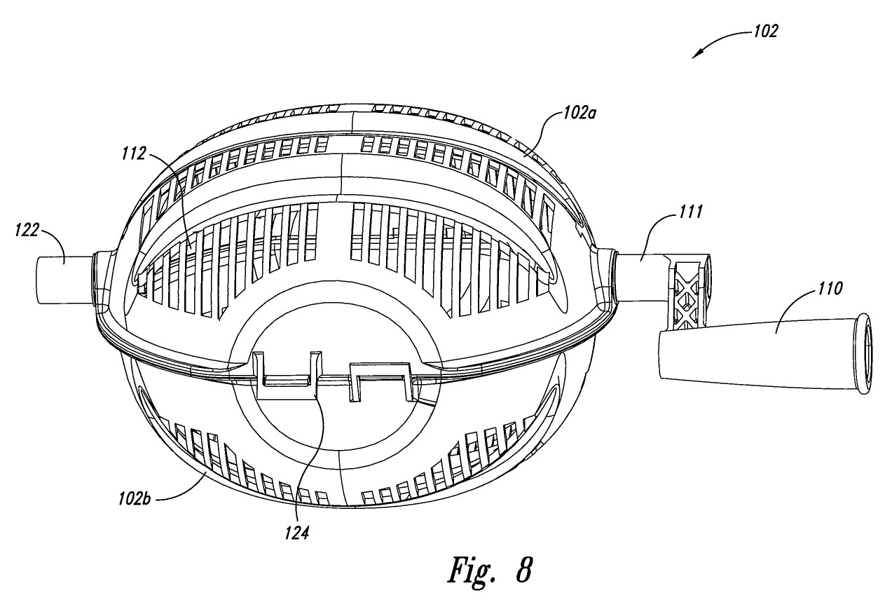

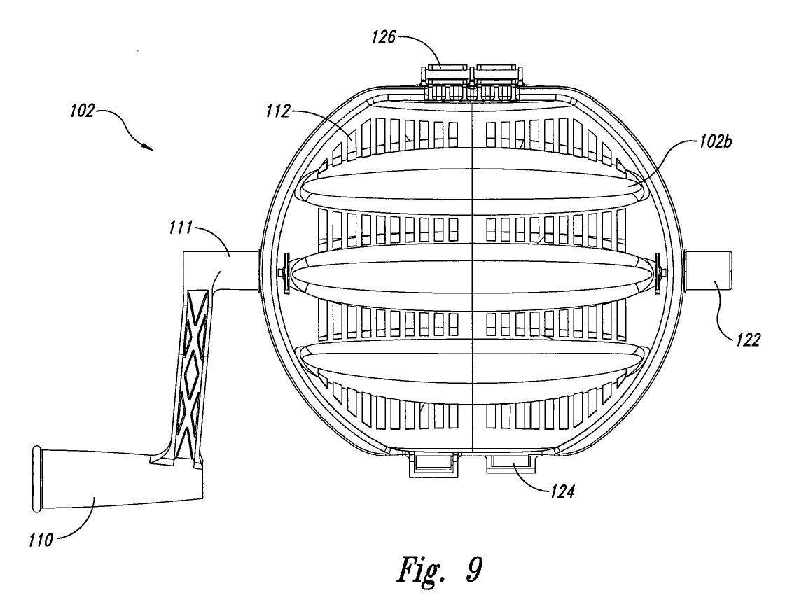

FIG. 8 is a schematic isometric view of a media separator device in accordance with another embodiment of the invention. FIG. 9 is a schematic top view of the media separator system illustrated in FIG. 8. Referring now to FIGS. 8 and 9, a media separator device independent of the support structure shown in the earlier Figures is illustrated. As shown in FIG. 8, the first portion and the second portion 102a, 102b can apertures 112. Alternatively, as disclosed above, the first portion 102a can include apertures 112, and the second portion 102b can be a solid shell (not shown) with no apertures.

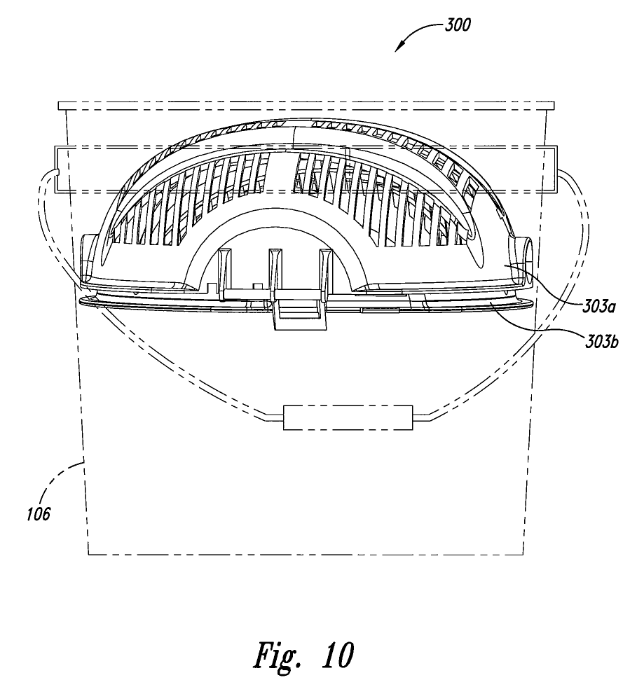

FIG. 10 is a schematic isometric view of the media separator system in accordance with another embodiment of the invention. Referring now to FIG. 10, for purposes of clarity, the support structure 106 is shown in dashed lines and a first and a second portion 303a, 303b of a dismantled media separation body are shown in solid lines. Thus, in the illustrated embodiment, the first and second portion 303a, 303b are contained within the support structure. According to one embodiment, the two portions 303a, 303b, of the media separator body are configured so that at least one portion 303a can partially nest or be received within the other portion 303b when not in use, such as during transit or in storage. The two portions 303a, 303b of the separator body are also sized to be received at least partially in the support structure 106. According to further embodiment, the support clamps, handle, shields, and projections (not shown for clarity) may also fit within the bucket along with the first and second portions 303a, 303b of the separator body. Providing a media separation body that can be disassembled for shipping and storage, reduces the size of the system for shipping and provides a convenient storage container when the device is not in use, thus protecting the device from damage when stored.

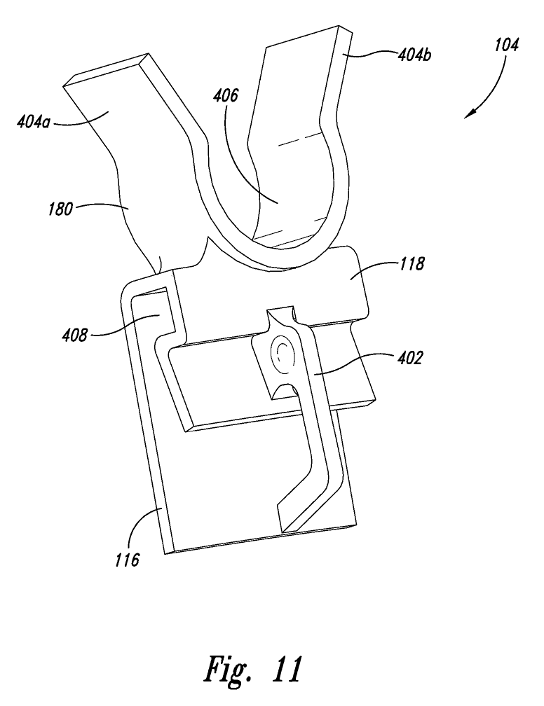

FIG. 11 is a retention device for use with the media separator system in accordance with another embodiment of the invention. The retention device 104 is as substantially as described with regard to previous figures. The retention device 104 includes a u-shaped portion 406 for receiving a projection (not shown). According to one embodiment, guide arms 404a, 404b are provided for guiding the projection into the u-shaped portion 406. A lower portion 408 of the retention member 104 provides a first extension 116 and a second extension 118 for retaining a top lip (not shown) of a support structure therein. In certain embodiments, a retention clip 402 is further provided to secure the retention device 104 in position during operation and to prevent the retention device 104 from twisting or inadvertently disengaging from the storage device.

C. Media Separator Methods of Use, Shipping and Storage

A method of shipping and storing a media separation device is further provided. In one embodiment, the method includes placing a multi-part media separator into a storage device. The method may further include placing a handle, at least one of a retention device, projections and/or shields. The method may further include placing a lid on the storage system and shipping the system from a first location to a second location.

According to further embodiments, the method includes opening a media separator body, placing a mixture of media and workpieces in the media separator body, closing the media separator body, placing the media separator body on a storage device. The handle is then turned to rotate the media separator body, and remove media from the mixture. In operation, the turning action causes the orientation of the brass to change with respect to the horizon; this causes the particulate material to separate from the brass cases. The media drains out the slots and the brass remains behind, now free of media and ready for processing. The method may further include opening the media separator body and removing the workpieces.

D. Conclusion

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number, respectively. When the claims use the word “or” in reference to a list of two or more items, that word covers all of the following interpretations of the word: any of the items in the list, all of the items in the list, and any combination of the items in the list.

The above detailed descriptions of embodiments of the invention are not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while steps are presented in a given order, alternative embodiments may perform steps in a different order. The various embodiments described herein can be combined to provide further embodiments.

In general, the terms used in the following claims should not be construed to limit the invention to the specific embodiments disclosed in the specification, unless the above detailed description explicitly defines such terms. While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the invention can be modified, if necessary, to employ media separation systems, devices and methods with various configurations, and concepts of the various patents, applications, and publications to provide yet further embodiments of the invention.

These and other changes can be made to the invention in light of the above-detailed description. In general, in the following claims, the terms used should not be construed to limit the invention to the specific embodiments disclosed in the specification and the claims, but should be construed to include all media separation systems, devices and methods that operate in accordance with the claims. Accordingly, the invention is not limited by the disclosure, but instead its scope is to be determined entirely by the following claims.

I/We claim:

1. A media separation system for separating workpieces from media configured for compact storage and transportation of the system, the system comprising:
a support structure; and
a media separation body having a plurality of interconnected portions, at least one of the portions containing apertures configured to allow media to pass through, wherein the portions are configured to nest together such that the portions are at least partially contained in the support structure.

2. The media separation system of claim 1 further comprising at least one of a retention device configured to engageably retain the support structure contained in the support structure.

3. The media separation system of claim 1 further comprising at least one of a projection coupled to the media separation body, wherein the projection is configured to releasably engage a retention device.

4. The media separation system of claim 1 further comprising a hinge between interconnected portions.

5. The media separation system of claim 1 further comprising a securing mechanism to releasably retain adjacent portions.

6. The media separation system of claim 1 wherein the support structure is a bucket.

7. The media separation system of claim 1 wherein the support structure is a tumbler.

8. The media separation system of claim 1 wherein the media separation body is completely contained in the support structure.

9. The media separation system of claim 1 wherein all portions include apertures configured to allow media to pass therethrough and further configured to prevent workpieces from passing therethrough.

10. A media separation device for separating workpieces from media sized and configured for compact storage and transportation of the device, the device comprising:
a first portion of a media separation device having a plurality of apertures to allow media to pass therethrough;
a second portion of a media separation device,
a securing mechanism interconnecting the first portion of the media separation device with the second portion wherein the first and the second portion connect to form a cavity;
a first projection and a second projection positioned substantially axially opposite each other and coupled to the second portion of a media separation device configured to rotationally support the interconnected first and second portion of the media separation device; and
a support structure sized and configured to support the first portion and the second portion of the media separation device in an assemble position and sized and configured to store the first portion and the second portion of the media separation device in an unassembled position.

11. The media separation device of claim 10 wherein the securing mechanism is a latch.

12. The media separation device of claim 10 further comprising a hinge between the first portion and the second portion.

13. The media separation device of claim 10 further comprising a handle extending from a first projection.

14. The media separation device of claim 10 wherein the second portion of the media separation device further comprises apertures to allow media to pass therethrough.

15. The media separation device of claim 10 wherein the support structure is a bucket.

16. The media separation device of claim 10 wherein the support structure is a tumbler.

17. The media separation device of claim 10 further comprising a first retention device releasably coupled to the first projection and a second retention device releasably coupled to a second projection.

18. The media separation device of claim 17 wherein the retention devices further releasably retain a top lip of the support structure.

19. The media separation device of claim 10 further comprising at least one of a shield releasably coupled to the support structure.

20. The media separation device of claim 10 further comprising a first shield releasably coupled to the support structure and a second shield releasably coupled to the support structure positioned on an opposite side of the support structure from the first shield.

21. The media separation device of claim 10 wherein the first portion and the second portion are reciprocally sized to allow the first portion to nest in the second portion in a stored position.

22. The media separation device of claim 21 wherein the nested portions are sized to be received in the support structure.

23. The media separation device of claim 22 further comprising a handle and retention devices contained in the support structure.

24. A method for shipping a media separation system comprising:
providing a support structure; and
positioning a first media separator portion and a second media separator portion within the support structure in an unassembled configuration.

25. The method for shipping a media separation system of claim 24 further comprising positioning a handle, a shield, and/or a retention device within the support structure.

26. The method for shipping a media separation system of claim 24 wherein the support structure is a tumbler.

27. The method for shipping a media separation system of claim 24 wherein the first media separator portion and second media separator portion are in a nested configuration within the support structure.

28. The method for shipping a media separation system of claim 24 wherein the first media separator portion includes apertures for allowing media to pass therethrough.
